(19) United States
(12) Patent Application Publication
(10) Pub. No.: US 2018/0027723 A1
(43) Pub. Date: Feb. 1, 2018

(54) TRACTOR MOUNTED EXCAVATION IMPLEMENT ENHANCEMENTS AND EXPANSIONS

(71) Applicant: Bruce Wade McGee, Meridian, MS (US)

(72) Inventor: Bruce Wade McGee, Meridian, MS (US)

(21) Appl. No.: 15/415,811

(22) Filed: Jan. 25, 2017

Related U.S. Application Data
(60) Provisional application No. 62/390,517, filed on Mar. 31, 2016.
(60) Provisional application No. 62/388,393, filed on Jan. 28, 2016.
(60) Provisional application No. 62/388,350, filed on Jan. 25, 2016.

(51) Int. Cl. A01B 33/10; E02F 5/14; A01B 33/08; A01B 33/02; E02F 5/08

(52) U.S. Cl. CPC A01B 33/103; A01B 33/021; E02F 5/08; A01B 33/082; E02F 5/14

(57) ABSTRACT

The objective of this application is to reveal enhancements and extensions of the previously patented Tractor-Mounted Excavation Implement, awarded Nov. 24, 2015 to Bruce Wade McGee, and assigned U.S. Pat. No. 9,194,103 B2. McGee's Tractor Mounted Excavation Implement is useful in small-scale construction, hobby farming or gardening, landscaping, irrigation, utilities and pipe laying, roadside or city development and maintenance in some areas, land-owner maintenance, and possibly firefighting with rapid excavation needs in some less dense forests. This application adds apparatuses to include usefulness in creating gardening or landscaping beds, and shallow graded excavations for sidewalk or simple slabs. Additionally, several other changes are proposed that enhance and extend usefulness of the implement, including improved power diversion to the implement's apparatuses, improved cutting element configuration, and an enhanced axle that more effectively loosens soil for excavation and “sweeps” excavated soil laterally.

### CROSS-REFERENCE TO PRIOR APPLICATIONS

This application claims benefit of the following Provisional patent applications by the present inventor, Bruce Wade McGee:
Provisional Patent Application No. 62/388,350 entitled “Rotational Bedder Apparatus” and dated Jan. 25, 2016.
Provisional Patent Application No. 62/388,393 entitled “Improved Rotator and Axle for Excavation Implement” and dated Jan. 28, 2016.
Provisional Patent Application No. 62/390,517 entitled “Excavation Implement Improvements” dated Mar. 31, 2016.

### BACKGROUND OF THE INVENTION

This application is primarily relevant as relates to the present inventor's previous patent for a Tractor-Mounted Excavation Implement, awarded Nov. 24, 2015 to Bruce Wade McGee, and assigned U.S. Pat. No. 9,194,103 B2. The patent has been assigned to McGee Innovation, LLC. A re-issue application has since been submitted to broaden several of the claims in the awarded patent, assigned Ser. No. 14/999,506, and dated May 17, 2016.

This patent application relates to excavation and dirt-working machines. McGee's Tractor Mounted Excavation Implement is useful in small-scale construction, hobby farming or gardening, landscaping, irrigation, utilities and pipe laying, roadside or city development and maintenance in some areas, land-owner maintenance, and possibly firefighting with rapid excavation needs in some less dense forests.

This application is for an improvement patent seeking to enhance and extend usefulness of McGee's Tractor-Mounted Excavation Implement.

### DISCUSSION OF PRIOR ART

The Tractor Mounted Excavation Implement is power-take-off driven and attaches to a tractor's 3-point-hitch, with multiple interchangeable rotational excavation apparatuses, described as task-associated. The implement is presented with three interchangeable apparatuses addressing four tasks, including apparatuses for foundation footers/trenches, rounded ditches, or shallow V-shaped ditches.

McGee's implement has the potential to revolutionize small-scale excavation. The unique value of McGee's implement is it's propensity toward usefulness in small-scale applications, but where speed and precise excavations are important requirements. Nevertheless, there are some improvements that will make McGee's implement even more useful. Several such improvements have been submitted as Provisional patent applications, as noted above, and will be addressed here in their entirety as “Enhancements and Expansions.”

The proposed enhancements and expansions include the addition of two apparatuses to extend the number and variety of tasks that can be accomplished. Additionally, several other enhancements have been conceptualized, including changes in the way power is diverted from the tractor to the apparatuses, the addition of adjustable and extendable tines or cutting elements to increase range of usefulness, and additions to the axle of certain apparatuses to improve the movement of excavated soil onto the banks of the excavated depression.

An identified need, for hobby farmers, gardeners and landscapers, is an apparatus for creating “beds” for planting rows or landscaping. Several versions of such machines exist in the prior art and in practical application, particularly in agriculture. However, current machines are large and require extra storage between uses. The proposed embodiment of an apparatus for McGee's implement is smaller, more readily interchanged between other apparatuses used with the implement. The benefit is particularly evident for those who own McGee's implement, avoiding the extra expense and storage of a larger implement developed solely for creating garden beds.

Another identified need, for construction and city maintenance professionals, is an apparatus for creating graded, shallow excavations for sidewalks and simple slabs of concrete or other material. Currently, simple excavations for small-scale usages are accomplished by hand with simple tools, perhaps with the assistance of a sod remover. Larger projects utilize heavy equipment designed to accomplish one or more steps in the process. The proposed embodiment of an apparatus for McGee's implement is relatively small and easy to use in more modest projects.

One enhancement of McGee's implement is related to how the power diversion is accomplished. In the previously patented embodiment, there is a proximal gear box and a more distal drive mechanism to reduce rotations and power the axles of the apparatuses. A simpler, more direct path to divert power from the power-take-off unit is to couple a speed-reducing gear box directly to the axle of the apparatus in use and extend the power directly from the PTO to the gear box. This allows for easier manufacturing and less potential for needed repairs.

Another enhancement to McGee's implement is related to the actual cutting elements attached to the face or body surface of each apparatus. In the previous embodiment, the claw-type cutting elements achieve the goal of guiding excavated soil directionally. However, some soils require breaking apart and loosening for more ease in excavating and directing soil. Additionally, in the previous embodiment, the width of excavation of trenches or foundation footings is limited to those produced when outer lateral sections are removed. Angled tines protruding laterally in various lengths could be useful to extend the width of the excavated area.

Lastly, further enhancement of the axle or axles used to support the task-associated excavating apparatuses is conceptualized. Particularly for the narrower apparatuses, a portion of the axle is exposed, allowing modifications that could further moving excavated soil along the axle laterally to the banks of the excavated area.

### BRIEF SUMMARY OF THE INVENTION

The over-arching objective of this invention is to make the McGee Tractor-Mounted Excavation Implement more versatile, adaptable, effective and efficient. Toward that end, the following Enhancements and Extensions are proposed.

A “bedder” apparatus is proposed that directs excavated soil toward the center, creating a mounded bed. The bedder is substantially cylindrical, but with a concave body, of hourglass shape. The bedder apparatus is different than the apparatuses already embodied in the McGee implement, in that there is less diameter in the center of the body, and claws or cutting elements are attached to the apparatus' face or surface, angled in the opposite direction, to direct soil medially between two excavated channels, rather than laterally.

A “sod and topsoil remover” apparatus is proposed that can loosen, harvest and direct topsoil and grass from an area being prepared for a simple sidewalk or slab. This apparatus is most similar to the apparatus already embodied in the McGee implement that is used for foundation footings or trenches. However, the “sod and topsoil remover” differs in that it is longer, for more width of excavation, and has a smaller diameter, for less depth of excavation.

An alternative embodiment of the power diversion system is conceptualized. The power-take-off rotation is directed to a gear box using a common drive shaft. The gear box is mounted such that the speed-reducing gear box is coupled with the currently used axle directly. The mechanism may require a torque-control or friction-reducing clutch, or minimally a shear pin or bolt.

An extension to the current embodiment of the body surface of each apparatus is conceptualized. In addition to the claw-like cutting elements for directional excavation, sharp cutting tines are connected to the face or body surface of each apparatus to protrude beyond the cutting elements or claws already embodied. The tines could be stationary, or adjustable or telescoping vertically away from the body of the apparatus, to provide alternatives based on excavation needs. Also, adjustable, laterally extendable claw-like cutting elements are proposed for the foundation footing/trencher apparatus, to extend the width of excavation. Movable tines should be bolted in place prior to each job.

An alternative embodiment of the axle or axles for the task-associated excavation apparatuses is conceptualized. In the areas of the axle or axles left exposed beyond the apparatuses, a blade or fin is attached circling the axle. This blade can be intermittent or continuous in a spiral path along the axle. This enhancement would be most beneficial for the narrower apparatuses, such as the two ditchers and the foundation footer/trencher apparatus. The newly conceptualized “bedder” apparatus would not benefit from sweeping soil laterally, and would not require sweeping it medially. The newly conceptualized “sod and topsoil remover” apparatus would not leave enough of the axle exposed to benefit from this enhancement.

### BRIEF DESCRIPTION OF THE SEVERAL VIEWS OF THE DRAWINGS

FIG. 1 is a perspective drawing of the “bedder” apparatus, installed in the McGee Tractor-Mounted Excavation Implement.

FIG. 2 shows a perspective “sod and topsoil remover” apparatus, installed in the McGee Tractor-Mounted Excavation Implement.

FIG. 3 shows a top view of a “direct drive” connection from the tractor's power-take-off unit to a simple speed-reducing gear box.

FIG. 4 shows a perspective view one possible embodiment of adjustable tines which extend from the body or face of an apparatus, extending the excavation range.

FIG. 4's perspective view also shows one possible embodiment of the improved axle, displaying sweeper fin-type blades angled intermittently around the exposed portion of the axle in a spiral path. Alternatively, a continuous sweeper blade could be installed along the same path.

### DETAILED DESCRIPTION OF INVENTION

This invention proposes enhancements and extensions to the previously patented Tractor Mounted Excavation Implement by Bruce Wade McGee, herein also referred to as “McGee Tractor Mounted Excavation Implement,” “McGee implement,” or simply “the implement.”

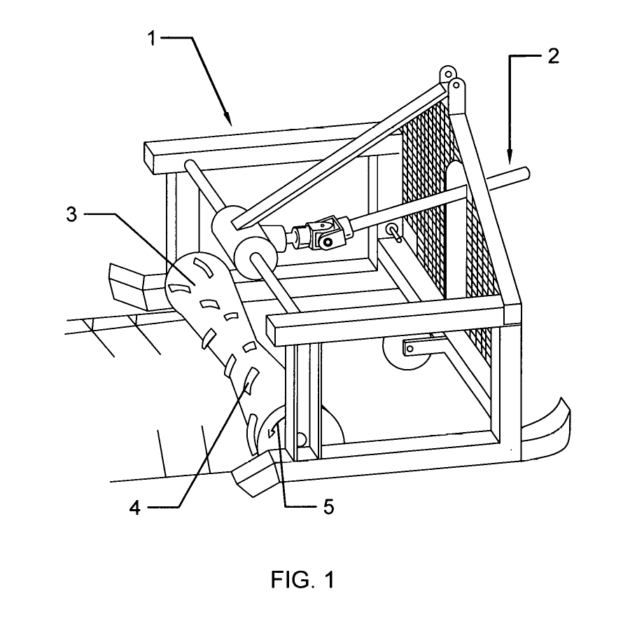

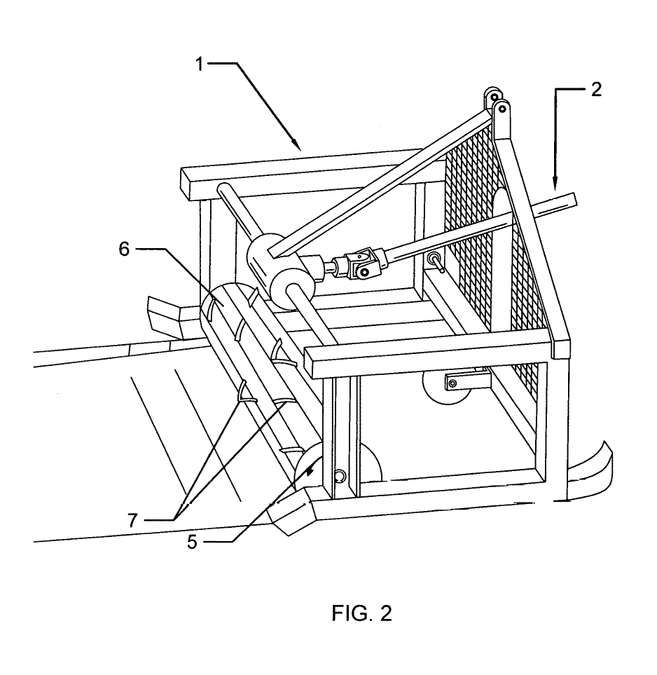

As seen in FIGS. 1 and 2, the Tractor-Mounted Excavation Implement, indicated by numeral 1, attaches to a tractor, not shown. The power-take-off unit drive shaft, indicated by numeral 2, supplies power to the axle of the apparatus in use. This portion of the drawings reflect the previously patented implement. The newly conceptualized apparatuses connected within the implement are further shown in FIGS. 1 and 2.

FIG. 1 shows a rotational bedder apparatus, previously presented in Provisional Patent Application No. 62/388,350 entitled “Rotational Bedder Apparatus” and dated Jan. 25, 2016.

As shown in FIG. 1, within Implement 1, is situated a bedder apparatus, indicated by numeral 3. The face of the bedder apparatus is surfaced with claws, indicated by numeral 4, in a similar manner to previously patented apparatuses, but angled medially toward center of apparatus. The direction of rotation of the apparatus itself is indicated arrows shown with numeral 5.

FIG. 2 shows a rotational “sod and topsoil remover” apparatus, previously conceptualized and included in Provisional Patent Application No. 62/390,517 entitled “Excavation Implement Improvements” dated Mar. 31, 2016.

As shown in FIG. 2, a rotational sod and topsoil remover apparatus, indicated by numeral 6, is situated within the implement. The direction of rotation and surfacing with claws, tines or blades, are similar to other previously embodied apparatuses. This apparatus is longer, preferably the width of a typical sidewalk, and excavates a shallower level area, such as is typical for a simple sidewalk or with multiple strips, a simple slab.

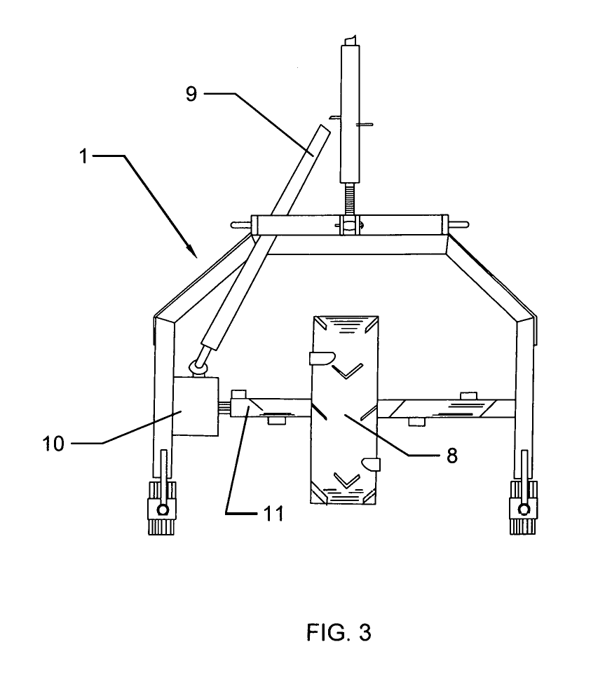

FIG. 3 shows an improved method of transferring power from the tractor's power-take-off unit to the apparatuses, as previously conceptualized and included in Provisional Patent Application No. 62/390,517 entitled “Excavation Implement Improvements” dated Mar. 31, 2016.

As seen in FIG. 3, the implement's perimetrical frame 1, and the selected apparatus 8, in this instance a trencher apparatus, are similarly positioned to previous embodiments. However, the tractor's power-take-off is connected to a drive shaft, indicated by numeral 9, which in turn directly attaches to and powers a gear box, indicated by numeral 10. The gear box is mounted such that the selected apparatus' 8 axle, indicated by numeral 11, is directly rotated. Gear box 10 incorporates a speed-reducing feature, lowering the revolutions-per-minute to a predetermined setting for the apparatus to be rotated slowly enough for effective excavation. Gear box 10 also is equipped with a slip clutch or sheer pin at the attachment point to prevent damage to equipment.

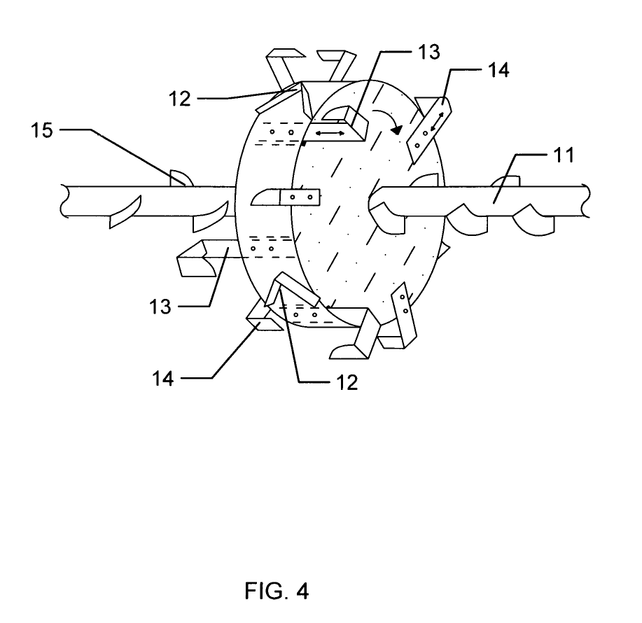

FIG. 4 shows improvements to the cutting elements and axle, as previously conceptualized and presented Provisional Patent Application No. 62/388,393 entitled “Improved Rotator and Axle for Excavation Implement” and dated Jan. 28, 2016. The Trencher Apparatus from the McGee Tractor Mounted Excavation Implement is shown, indicated by numeral 8, on its axle 11, with outer sections from the Foundation Footer Apparatus removed.

As shown in FIG. 4, in addition to the claws or cutting elements, indicated by numeral 12, that are angled to force soil directionally, there are adjustable tines or blades. There are five of six laterally adjustable tines shown, indicated by numeral 13. Lateral tines 13 are telescoped laterally out from a pocket on the face of the apparatus and secured in position, with several potential lateral positions based on the need of the excavation task. These can provide additional width of excavated area. Additionally, there are five of six vertically adjustable tines shown, indicated by numeral 14. Vertical tines 14 adjust or telescope vertically, extending away from the center of the apparatus' body, with potential vertical positions available based on needs of the excavation task and the soil to be excavated. These would be particularly useful in more dense soils to break apart soil so that claws or cuttings elements can move it laterally or medially with less difficulty. Alternatively, tines shown by numerals 13 and 14 could be positioned and secured, or permanently secured immovably to the face or body of the apparatus, based on the most likely needs of the particular task-associated excavation. The vertically extended tines could be used on all of the apparatuses, previously patented, and currently proposed. The laterally extended tines would be useful only on the foundation footer and trencher apparatuses.

Additionally, as shown in FIG. 4, the exposed portion of the axle, indicated by numeral 8, is shown with intermittent fin-type sweeper blades, indicated by numeral 15, attached in a spiral path around the axle. The fins or blades located more medially, toward the body of the apparatus, would be folded out or attached and locked in place after the outer sections of the foundation footer apparatus are removed.

1. A rotational excavating apparatus, to be mounted by axle into the Tractor-Mounted Excavation Implement, whereby landscape or gardening raised beds may be excavated, comprising:
a. a substantially cylindrical apparatus, concave-faced, of hourglass shape, and
b. a means of harvesting soil and depositing spoils toward the center of the apparatus, comprising:
i. claws, or cutting elements, attached to face at medially directed angles to thrust soil upward and medially, and
ii. a rotatable axle with power diversion from the tractor's power-take-off unit to the axle.

2. A rotational excavating apparatus, to be mounted by axle into the Tractor-Mounted Excavation Implement, whereby shallow graded areas for sidewalks or simple slabs may be excavated, comprising:
a. substantially cylindrical, tubular roller-shaped body, and
b. a means of harvesting soil and depositing spoils out laterally away from resulting depression, comprising:
i. claws, or cutting elements, attached to body at laterally directed angles to thrust soil upward and laterally, and
ii. a rotatable axle with power diversion from the tractor's power-take-off unit to the axle.

3. A means of more directly diverting power from the tractor's power-take-off unit to the axle of the selected task-associated excavation apparatus, comprising:
a. a drive shaft reaching from said power-take-off unit to the gear box of the implement, and
b. said gear box situated to directly couple with axle of selected task-associated excavation apparatus.

4. The gear box described in claim 3, wherein said gear box reduces rotation rate at a pre-determined ratio.

5. The gear box described in claim 3, wherein the mechanism employs a means to reduce torque and friction, whereby avoiding damage to said gearbox when sudden obstacles are encountered in operation.

6. A means of accommodating extended requirements of task-associated excavation apparatuses, comprising:
a. a plurality of laterally extruding tines from the face of each apparatus, whereby the width of excavated area can be extended, and
b. a plurality of vertically extruding tines from the body of each apparatus, whereby the soil is broken apart for ease in harvesting and directing soil.

7. The pluralities of tines described in claim 6, wherein said tines can be secured immovably, or made adjustable by extending and locking or bolting in place.

8. A plurality of angled fins or blades for attachment to the exposed portion of the axles of the task-associated excavation apparatuses, whereby excavated soil is swept laterally toward banks of resulting depression
